(19) United States
(12) Patent Application Publication
(10) Pub. No.: US 2012/0317376 A1
(43) Pub. Date: Dec. 13, 2012

(54) ROW BUFFER REGISTER FILE

(75) Inventor: Gabriel H. LOH, Bellevue, WA (US)

(73) Assignee: ADVANCED MICRO DEVICES, INC., Sunnyvale, CA (US)

(21) Appl. No.: 13/157,974

(22) Filed: Jun. 10, 2011

(51) Int. Cl. G06F 12/00

(52) U.S. Cl. 711/154; 711/E12.001

(57) ABSTRACT

A memory controller of a device stores data from each of a plurality of row buffers of a multiple-bank memory device in a corresponding entry of a row buffer register file (RBRF) provided in a logic/interface layer of the memory device. The memory controller serves a first memory request from an entry in the RBRF responsive to determining that the entry stores data from a first row buffer associated with the first memory request.

### BACKGROUND

Three-dimensional (3D)-stacked or 3D-integrated memory devices, such as a dynamic random-access memory (DRAM), may include multiple storage or memory layers provided on a logic/interface layer that implements DRAM peripheral logic and other interface circuits. It has been proposed to include a row buffer cache (RBC) or a memory-side cache within the DRAM memory layers or chips. A RBC contains a number of the most recently accessed rows from the DRAM memory layer. Providing access to a cached row buffer can result in lower access latency since the RBC avoids the latencies associated with writing and reading rows from the DRAM memory layer. The RBC effectively implements a least recently used (LRU) replacement policy.

DRAM accesses or “reads” require sensing a charge stored in individual bit cells and latching the corresponding amplified digital values in a row buffer. Since reading a DRAM destroys the bit cell content, the content of a row buffer must eventually be written back to the DRAM. Reading a row of a memory array (e.g., a DRAM array) is called “opening” or “activating” the row, and writing a row back to the memory array is called “closing” the row. A typical DRAM array (or bank) contains a single row buffer. Thus, only a single row (or page) can be accessed or read at a time per bank. Reading and writing a row that is already open incurs a lower latency because the data associated with the row is directly accessible from the row buffer. Reading and writing a row that is not already open incurs additional latency due to closing another row (e.g., if another row is currently active) and opening the desired row. Typically there is a single row buffer associated with each DRAM bank.

It has been proposed to use a RBC, also call a “DRAM cache,” that supports multiple open rows per bank or memory layer. The RBC is a separate structure from the internal row buffer associated with a memory bank's sense and write logic. The RBC stores a number of last accessed rows from the memory bank. A memory controller may store identifiers (e.g., tags) corresponding to what is stored in the RBC, and thus, may detect when a row is already open (i.e., stored in the RBC). When a requested row is available in the RBC, the memory controller may issue a read/write command (i.e., a column access) for the requested row, without closing any other rows and opening a new row. When a requested row is not available in the RBC, the memory controller may close a LRU row and may open the requested row before issuing the read/write command for the requested row. However, such an arrangement creates latency issues similar to conventional DRAM row-conflict access techniques.

### SUMMARY OF EMBODIMENTS OF THE INVENTION

According to one embodiment, a method may include: storing data from each of a plurality of row buffers of a multiple-bank memory device in a corresponding entry of a row buffer register file (RBRF) provided in a logic/interface layer of the memory device; and serving a first memory request from an entry in the RBRF responsive to determining that the entry stores data from a first row buffer associated with the first memory request.

According to another embodiment, a memory controller of a device may include processing logic to: store data from each of a plurality of row buffers of a multiple-bank memory device in a corresponding entry of a row buffer register file (RBRF) provided in a logic/interface layer of the memory device, and serve a first memory request from an entry in the RBRF responsive to determining that the entry stores data from a first row buffer associated with the first memory request.

According to still another embodiment, a device may include a memory device that includes a memory layer with memory banks and corresponding row buffers, and a logic/interface layer with a row buffer register file (RBRF). The device may also include a memory controller to store data from each of the row buffers in a corresponding entry of the RBRF, and serve a first memory request from an entry in the RBRF responsive to determining that the entry stores data from a first row buffer associated with the first memory request.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram of an example memory arrangement according to an embodiment described herein;

FIG. 2 is a diagram of example components of a device that may include the memory arrangement of FIG. 1;

FIG. 3 is a diagram of example components of a portion of the memory arrangement depicted in FIG. 1;

FIG. 4 is a diagram of example operations capable of being performed by components depicted in FIG. 3;

FIG. 5 is a diagram of further example operations capable of being performed by components illustrated in FIG. 3;

FIG. 6 is a diagram of example operations capable of being performed by components depicted in FIGS. 2 and 3;

FIGS. 7A and 7B are diagrams of example operations capable of being performed by components illustrated in FIG. 3;

FIG. 8 is a flow chart of an example process for utilizing a row buffer register file (RBRF) according to an embodiment described herein; and

FIG. 9 is a flow chart of another example process for utilizing a RBRF according to an embodiment described herein.

### DETAILED DESCRIPTION

The following detailed description refers to the accompanying drawings. The same reference numbers in different drawings may identify the same or similar elements.

### Overview

Systems and/or methods described herein may utilize a logic/interface layer of a memory device to implement a row buffer register file (RBRF). The RBRF may permit a memory to simultaneously keep multiple rows of memory open in order to improve memory access times. Multiple internal row buffers of the memory device may permit multiple rows of memory to be simultaneously opened, while the RBRF may maintain entries associated with the internal row buffers. The entries in the RBRF may be visible to and controlled by a memory controller. The memory controller may open or close particular rows at particular times, which may enable the memory controller to more efficiently schedule memory requests to improve performance, fairness, and/or power.

The terms “component” and “device,” as used herein, are intended to be broadly construed to include hardware (e.g., a processor, a microprocessor, an application-specific integrated circuit (ASIC), a field-programmable gate array (FPGA), a chip, a memory device (e.g., a read only memory (ROM), a random access memory (RAM), etc.), etc.) or a combination of hardware and software (e.g., a processor, microprocessor, ASIC, etc. executing software contained in a memory device).

### Example Memory Arrangement

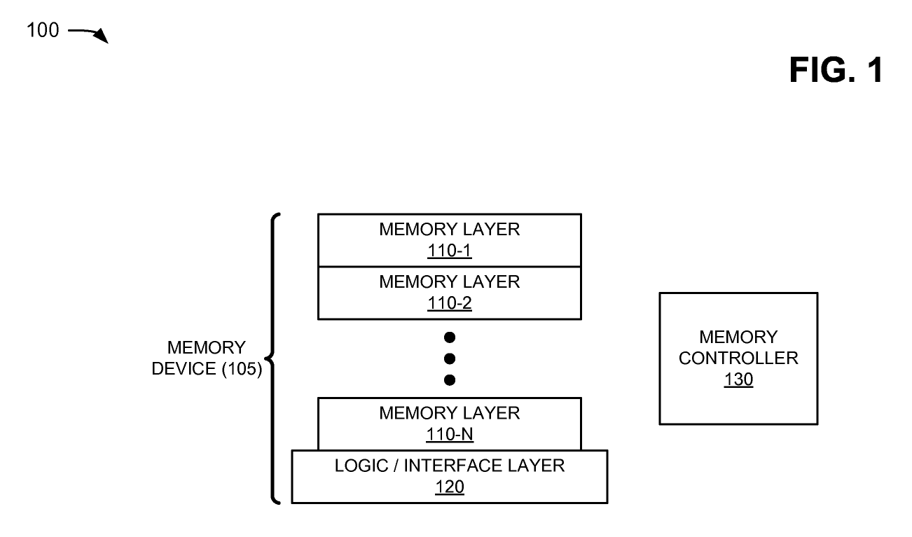

FIG. 1 is a diagram of an example memory arrangement 100 according to an embodiment described herein. As shown, memory arrangement 100 may include a memory device 105 with memory layers 110-1, . . . , 110-N (N>1) (collectively referred to herein as “memory layers 110,” and, in some instances, singularly as “memory layer 110”) provided on a logic/interface layer 120. Memory arrangement 100 may further include a memory controller 130. Components of memory arrangement 100 may interconnect via wired and/or wireless connections.

Memory device 105 may include a RAM, a static RAM (SRAM), a dynamic RAM (DRAM), a read only memory (ROM), a phase-change memory, a memristor, other types of static storage devices that may store static information and/or instructions, and/or other types of dynamic storage devices that may store information and instructions. In one example embodiment, memory device 105 may include a 3D-stacked DRAM.

Memory layer 110 may include a small block of semiconductor material (e.g., a die) on which a memory circuit is fabricated. In one example embodiment, memory layers 110 may include die-stacked memories formed from multiple layers of DRAM dies.

Logic/interface layer 120 may include one or more layers of semiconductor material that implement peripheral logic, input/output circuits, discrete Fourier transform (DFT) circuits, and other circuits. In one example embodiment, logic/interface layer 120 may include additional capacity for implementing one or more RBRFs described herein. In other embodiments, logic/interface layer 120 may implement one RBRF per DRAM channel.

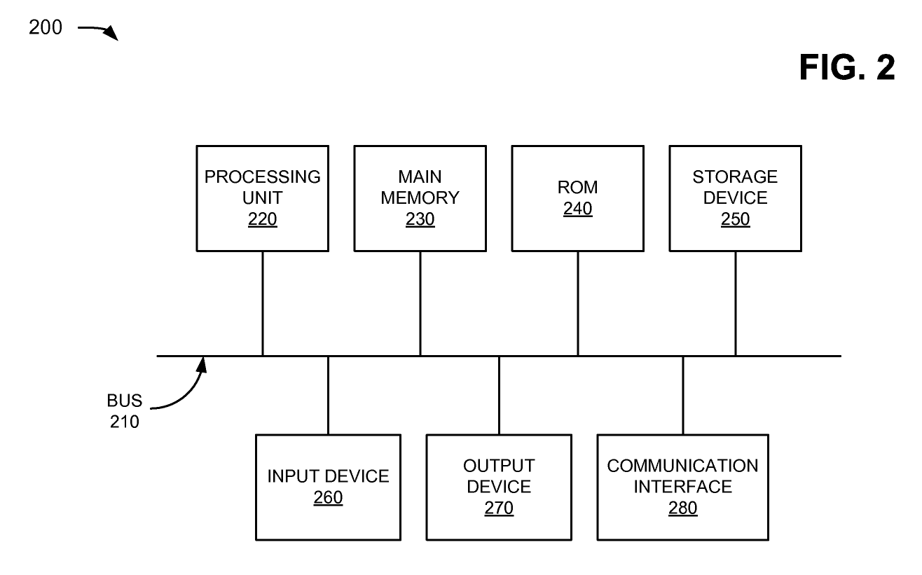

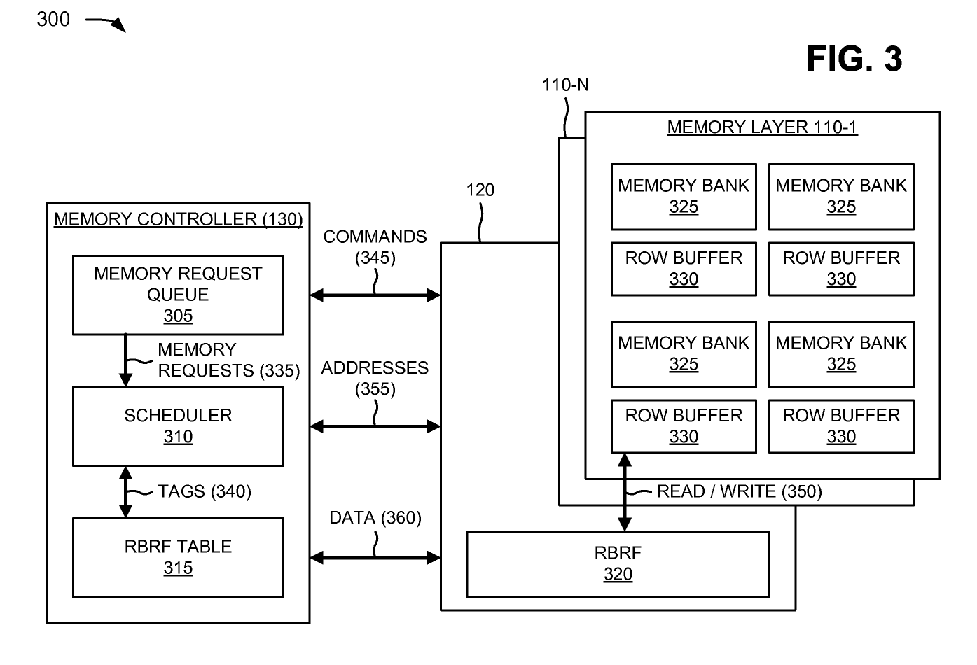

Memory controller 130 may be implemented in conjunction with one or more processors (e.g., processing unit 220 of FIG. 2) to act as an interface between the processors/cache and memory device 105. In one embodiment, memory controller 130 may include a digital circuit that manages flow of data going to and from memory device 105. Memory controller 130 may be a separate chip or may be integrated into another chip (e.g., in a processing unit described below in FIG. 2). Memory controller 130 may include logic to read from and write to memory device 105, and to refresh memory device 105 by sending current through memory device 105. Reading and writing from/to memory device 105 may be facilitated by use of multiplexers and demultiplexers. Memory controller 130 may select a correct row and column address of memory device 105 as inputs to the multiplexer. The demultiplexer may select the correct memory location of memory device 105, and may return data associated with the memory location. Further details of memory controller 130 are provided below in connection with, for example, FIGS. 3-9.

Although FIG. 1 shows example components of memory arrangement 100, in other embodiments, memory arrangement 100 may include fewer components, different components, differently arranged components, or additional components than depicted in FIG. 1. Alternatively, or additionally, one or more components of memory arrangement 100 may perform one or more other tasks described as being performed by one or more other components of memory arrangement 100.

For example, although FIG. 1 shows memory device 105 as a die-stacked DRAM structure, in other embodiments, memory device 105 may be implemented in two-dimensional (2D) DRAM chips or other alternative memory technologies (e.g., a phase-change memory). In another example, one or more RBRFs may be implemented in a location other than logic/interface layer 120, such as in memory controller 130 or in a processing unit described below in FIG. 2.

### Example Device Configuration

FIG. 2 is a diagram of example components of a device that may include memory arrangement 100. Device 200 may include any computation or communication device that utilizes memory arrangement 100. For example, device 200 may include a personal computer, a desktop computer, a laptop computer, a tablet computer, a server device, a radiotelephone, a personal communications system (PCS) terminal, a personal digital assistant (PDA), a cellular telephone, a smart phone, and/or other types computation or communication devices.

As illustrated in FIG. 2, device 200 may include a bus 210, a processing unit 220, a main memory 230, a ROM 240, a storage device 250, an input device 260, an output device 270, and/or a communication interface 280. Bus 210 may include a path that permits communication among the components of device 200.

Processing unit 220 may include one or more processors (e.g., multi-core processors), microprocessors, ASICS, FPGAs, a central processing unit (CPU), a graphical processing unit (GPU), or other types of processing units that may interpret and execute instructions. In one embodiment, processing unit 220 may include a single processor that includes multiple cores. Main memory 230 may include a RAM, a dynamic RAM (DRAM), and/or another type of dynamic storage device that may store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive. In one embodiment, one or more of main memory 230, ROM 240, and storage device 250 may correspond to memory arrangement 100.

Input device 260 may include a mechanism that permits an operator to input information to device 200, such as a keyboard, a mouse, a pen, a microphone, voice recognition and/or biometric mechanisms, a touch screen, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a non-transitory memory device. A memory device may include space within a single physical memory device or spread across multiple physical memory devices. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of or in combination with software instructions to implement processes described herein. Thus, embodiments described herein are not limited to any specific combination of hardware circuitry and software.

Although FIG. 2 shows example components of device 200, in other embodiments, device 200 may include fewer components, different components, differently arranged components, or additional components than depicted in FIG. 2. Alternatively, or additionally, one or more components of device 200 may perform one or more other tasks described as being performed by one or more other components of device 200.

### Example Components/Operation of Memory Arrangement

FIG. 3 is a diagram of example components of a portion 300 of memory arrangement 100. As shown, memory arrangement portion 300 may include memory layers 110, logic/interface layer 120, and memory controller 130. Memory layers 110, logic/interface layer 120, and memory controller 130 may include the features described above in connection with, for example, FIG. 1. As further shown in FIG. 3, memory controller 130 may include a memory request queue 305, a scheduler 310, and a RBRF table 315; logic/interface layer 120 may include a RBRF 320; and each memory layer 110 may include memory banks 325 and corresponding row buffers 330.

Memory request queue 305 may receive memory requests 335 (e.g., from processing unit 220, FIG. 2), and may store memory requests 335 in a queue until memory requests 335 are ready to be processed by scheduler 310.

Scheduler 310 may scan the pending memory requests 335 held in memory request queue 305, and may retrieve memory requests 335 from memory request queue 305. In one example, scheduler 310 may retrieve memory requests 335 in the order they are received by memory request queue 305. Scheduler 310 may ensure correct enforcement of DRAM-related timing constraints, and may manage allocation and de-allocation of entries in RBRF 320. Based on memory requests 335, scheduler 310 may determine what commands 345 to provide to memory layers 110 and/or logic/interface layer 120. For example, scheduler 310 may issue commands 345 to activate, read, write, or close rows in memory banks 325 of memory layers 110. Scheduler 310 may issue commands 345 to transfer contents of a row buffer 330 to an entry of RBRF 320, or may issue commands 345 to transfer contents of an entry of RBRF 320 back to a row buffer 330, as indicated by reference number 350. Furthermore, scheduler 310 may issue commands 345 to read or write directly from entries of RBRF 320.

RBRF table 315 may include a table (or other arrangement of information) of RBRF tags 340 that track how rows (if any) are stored as entries of RBRF 320. RBRF table 315 may store state information for correct operation of memory device 105 (FIG. 1), such as information describing whether a row needs to be written back to a memory bank 325. RBRF table 315 may also store state information for performance optimization and/or policy enforcement, such as information describing which processing unit 220 core requested a row, information describing when a row was last accessed, etc.

As further shown in FIG. 3, memory controller 130 may exchange addresses 355 and/or data 360 with memory device 105. Addresses 355 may include address information associated with locations (e.g., in memory banks 325) of memory layers 110. Data 360 may include information associated with memory requests 335, tags 340, etc.

RBRF 320 may include a cache for storing entries associated with information provided in row buffers 330. In one example embodiment, RBRF 320 may store, as entries, copies of data provided in row buffers 330. Memory controller 130 may have explicit control over the allocation and de-allocation of the entries provided in RBRF 320. This may enable memory controller 130 to optimize memory device 105 in a way that is not possible with a conventional LRU-based RBC. In one example embodiment, one or more RBRFs 320 may be provided in logic/interface layer 120 of memory arrangement 100. In other embodiments, one or more RBRFs 320 may be provided in other locations of memory arrangement 100. For example, one or more RBRFs 320 may be provided next to or directly in memory controller 130 using an off-chip (non-stacked) memory.

Each of memory banks 325 may include an individual section of data stored in memory device 105. In one example, each of memory banks 325 may contain data that is stored temporarily and is used as a memory cache. Memory banks 325 may be ordered consecutively, which may provide easy access to individual items stored in memory device 105. Each of memory banks 325 may include a physical section of memory device 105 that may be designed to handle information transfers independently.

Each of row buffers 330 may be associated with a corresponding one of memory banks 325. Each row buffer 330 may include a buffer to temporarily store a single row (or a page) of data provided in a corresponding memory bank 325. Reading and writing a row that is already open may incur a lower latency because the data associated with the row is directly accessible from row buffer 330. However, reading and writing a row that is not already open may incur additional latency due to writing another row (e.g., if another row is currently active) from row buffer 330 to memory bank 320 and reading the desired row from memory bank 325 into row buffer 330.

In one example, a data path between RBRF 320 and row buffers 330 may be smaller in size than an entry of RBRF 320 and/or data stored in a single row buffer 330. As a result, transferring data between RBRF 320 and row buffers 330 may take multiple cycles if data in an entire row buffer 330 is to be transferred. In order reduce the number of cycles, and in one embodiment, scheduler 310 may request transfer of a partial row (e.g., a row that is a common power of two in size). The transfer of the partial row may reduce contention for internal buses and may reduce power overhead by not transferring entire rows when not needed. Since data transfers between RBRF 320 and row buffers 330 may be constrained by an internal bus width, RBRF 320 may be banked to allow for more access level parallelism. For example, with a 256-bit internal bus, a 1024-byte row size may require sixteen (16) cycles to transfer between RBRF 320 and row buffer 330, assuming double data rate transfers. Instead of using a single 1024-byte port on RBRF 320, RBRF 320 may be banked into thirty-two (32) memory banks each with individual 32-byte ports. In such an arrangement, multiple transactions between memory controller 130 and RBRF 320, between RBRF 320 and row buffers 330, and/or between memory controller 130 and row buffers 330 may be overlapped.

Although FIG. 3 shows example components of memory arrangement portion 300, in other embodiments, memory arrangement portion 300 may include fewer components, different components, differently arranged components, or additional components than depicted in FIG. 3. Alternatively, or additionally, one or more components of memory arrangement portion 300 may perform one or more other tasks described as being performed by one or more other components of memory arrangement portion 300.

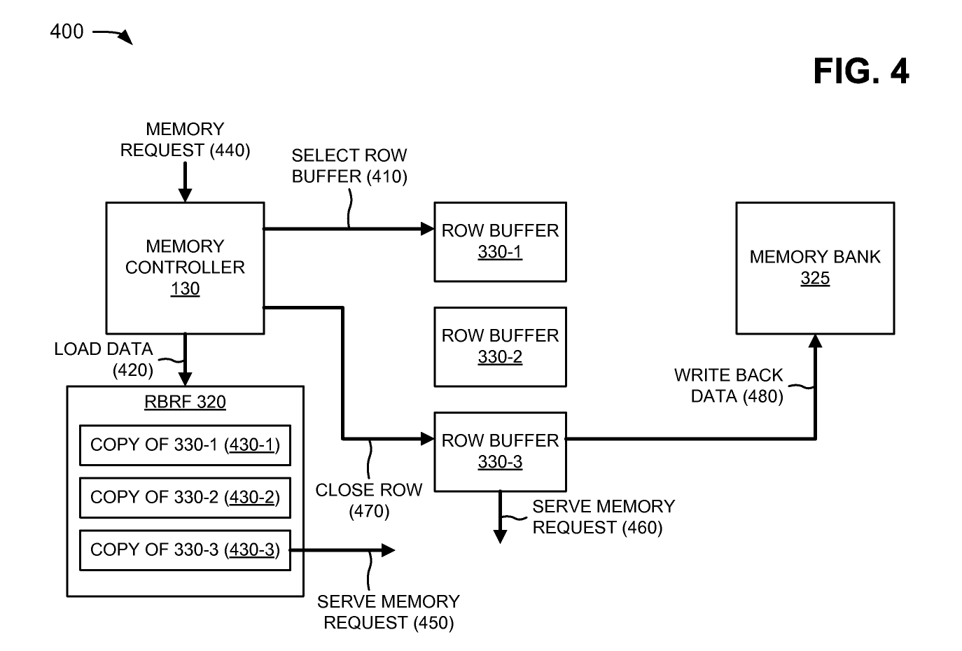

FIG. 4 is a diagram of example operations 400 capable of being performed by components of memory arrangement 100. As shown, the components of memory arrangement 100 may include memory controller 130, RBRF 320, memory bank 325, and row buffers 330-1, 330-2, and 330-3 (“row buffers 330” collectively). Memory controller 130, RBRF 320, memory bank 325, and row buffers 330 may include the features described above in connection with, for example, one or more of FIGS. 1-3.

As further shown in FIG. 4, rather than using a LRU entry, memory controller 130 may select one of row buffers 330 from which to load data into RBRF 320, as indicated by reference 410. Memory controller 130 may instruct memory bank 325 to load data (e.g., a row) from memory bank 325 into the selected one of row buffers 330 (e.g., row buffer 330-1). In one example, memory controller 130 may select row buffer 330-1, and may load a copy of data from row buffer 330-1, as indicated by reference number 420, into an entry 430-1 of RBRF 320. Memory controller 130 may load copies of data from row buffers 330-2 and 330-3 into entries 430-2 and 430-3, respectively, of RBRF 320.

When memory controller 130 receives a memory request 440, memory controller 130 may determine whether the information requested by memory request 440 is stored in an entry of RBRF 320. If the information requested by memory request 440 is stored in an entry of RBRF 320, memory controller 130 may serve memory request 440 with the entry of RBRF 320. For example, if memory request 440 requests information contained in entry 430-3 of RBRF 320, memory controller 130 may serve memory request 440 with entry 430-3, as indicated by reference number 450. If the information requested by memory request 440 is not stored in an entry of RBRF 320, memory controller 130 may serve memory request 440 via one of row buffers 330. For example, if memory request 440 requests information not contained in RBRF 320 but contained in row buffer 330-3, memory controller 130 may serve memory request 440 with row buffer 330-3, as indicated by reference number 460.

Memory controller 130 may explicitly close rows in row buffers 330, as indicated by reference number 470, rather than closing a row in response to an activation request for a row that is not already open. For example, memory controller 130 may proactively close a particular row when memory controller 130 determines that it is unlikely that there will be any further requests for the particular row (e.g., when no pending memory requests for the particular row exist in memory request queue 305). Such an arrangement may remove the latency associated with closing a row in response to an activation request for a row that is not already open. When memory controller 130 closes a row in a row buffer 330 (e.g., row buffer 330-3), data contained in row buffer 330-3 may be written back to memory bank 325, as indicated by reference number 480.

In one example embodiment, memory controller 130 may determine whether to create an entry in RBRF 320 for a memory request. For example, if a particular row is requested by a single memory request, memory controller 130 may serve the single memory request directly from one of row buffers 330, without creating an entry in RBRF 320.

Although FIG. 4 shows example operations 400 capable of being performed by components of memory arrangement 100, in other embodiments, memory arrangement 100 may perform less operations, different operations, or additional operations than depicted in FIG. 4. Alternatively, or additionally, one or more components of memory arrangement 100 may perform one or more other operations described as being performed by one or more other components of memory arrangement 100.

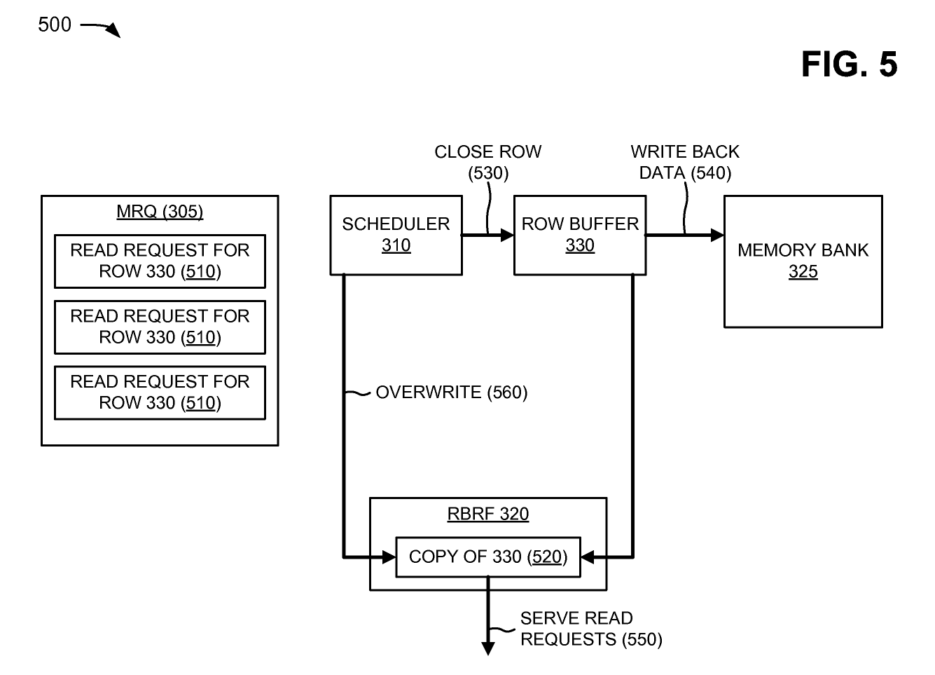

FIG. 5 is a diagram of further example operations 500 capable of being performed by components of memory arrangement 100. As shown, the components of memory arrangement 100 may include memory request queue (MRQ) 305, scheduler 310, RBRF 320, memory bank 325, and row buffer 330. Memory request queue 305, scheduler 310, RBRF 320, memory bank 325, and row buffer 330 may include the features described above in connection with, for example, one or more of FIGS. 1-4.

As further shown in FIG. 5, in one example, memory request queue 305 may include several read requests 510 for a row contained in row buffer 330. However, memory request queue 305 may not include write requests for the row contained in row buffer 330. Based on read requests 510, scheduler 310 may cause a copy of data (e.g., a row) stored in row buffer 330 to be stored in an entry 520 of RBRF 320. After creating entry 520 in RBRF 320, scheduler 310 may close the row stored in row buffer 330, as indicated by reference number 530. Row buffer 330, in turn, may write back its stored data to memory bank 325, as indicated by reference number 540. After all of read requests 510 have been served by entry 520 in RBRF 320, scheduler 310 may overwrite 560 entry 520 in RBRF 320, without writing back the data of entry 520 to memory bank 325, since the data was already written back to memory bank 325 and was not modified.

Alternatively, or additionally, scheduler 310 may cause a copy of the row stored in row buffer 330 to be stored in entry 520 of RBRF 320, and may (e.g., subject to circuit-level timing constraints) activate another row and store the other row in row buffer 330. In such an arrangement and after read requests 510 have been served by entry 520 in RBRF 320, scheduler 310 may transfer the data of entry 520 to row buffer 330 and may instruct row buffer 330 to write back the transferred data of entry 520 to memory bank 325.

Although FIG. 5 shows example operations 500 capable of being performed by components of memory arrangement 100, in other embodiments, memory arrangement 100 may perform less operations, different operations, or additional operations than depicted in FIG. 5. Alternatively, or additionally, one or more components of memory arrangement 100 may perform one or more other operations described as being performed by one or more other components of memory arrangement 100.

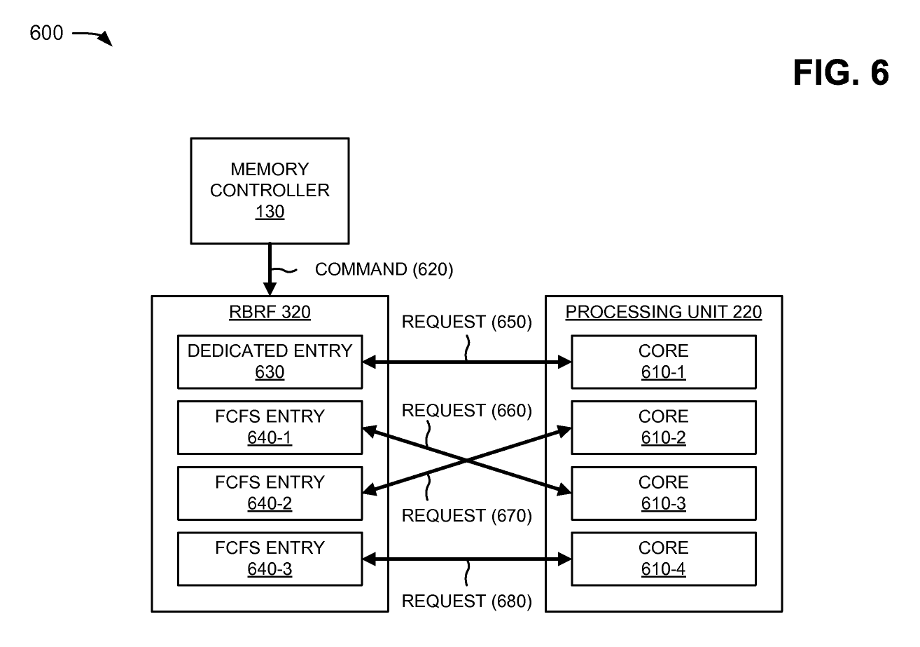

FIG. 6 is a diagram of example operations 600 capable of being performed by components of memory arrangement 100 and by processing unit 220. As shown, the components of memory arrangement 100 may include memory controller 130 and RBRF 320. Memory controller 130, RBRF 320, and processing unit 220 may include the features described above in connection with, for example, one or more of FIGS. 1-5.

As further shown in FIG. 6, processing unit 220 may include multiple cores 610-1, 610-2, 610-3, etc. (collectively referred to herein as “cores 610”). Cores 610 may be integrated onto a single integrated circuit die (e.g., a chip multiprocessor (CMP)) or may be integrated onto multiple dies in a single chip package. Each of cores 610 may include a processor, a microprocessor, or another type of processing unit that may interpret and execute instructions.

Memory controller 130 may provide a command 620 to RBRF 320. Command 620 may instruct RBRF 320 to allocate (e.g., at least temporarily) a single entry of RBRF 320 for one of cores 610, and to dynamically allocate remaining entries of RBRF 320 to core 610-1 and/or to other cores 610 on a first-come, first-serve (FCFS) basis. For example, command 620 may instruct RBRF 320 to allocate a dedicated entry 630 for core 610-1, and to dynamically allocate FCFS entries 640-1, 640-2, and 640-3 for cores 610-2, 610-3, and/or 610-4. Thus, dedicated entry 630 of RBRF 320 may serve a memory request generated by core 610-1, as indicated by reference number 650. FCFS entry 640-1 of RBRF 320 may serve a first memory request generated by the remaining cores 610 (e.g., by core 610-3), as indicated by reference number 660. FCFS entry 640-2 of RBRF 320 may serve a second memory request generated by the remaining cores 610 (e.g., by core 610-2), as indicated by reference number 670. FCFS entry 640-3 of RBRF 320 may serve a third memory request generated by the remaining cores 610 (e.g., by core 610-4), as indicated by reference number 680.

The operations depicted in FIG. 6 may be useful for maintaining relatively high RBRF 320 hit rate for core 610-1 even though the remaining cores 610 may be issuing memory requests at higher rates. With RBRF 320, memory controller 130 may implement a variety of policies to balance fairness and may perform different actions to optimize for latency or bandwidth on an application-by-application (or core-by-core) basis. In contrast, in a system using a RBC, memory requests from cores 610-2, 610-3, and 610-4 may quickly cause the RBC entry for core 610-1 to be evicted before any subsequent memory requests for core 610-1 have arrived. When the subsequent memory requests for core 610-1 do arrive, the subsequent memory requests will experience delays associated with reactivation of desired rows and possibly additional delays associated with evicting a RBC entry. Similar scenarios may occur with a mix of GPU-based and CPU-based memory requests.

Although FIG. 6 shows example operations 600 capable of being performed by components of memory arrangement 100 and by processing unit 220, in other embodiments, memory arrangement 100 may perform less operations, different operations, or additional operations than depicted in FIG. 6. Alternatively, or additionally, one or more components of memory arrangement 100 may perform one or more other operations described as being performed by one or more other components of memory arrangement 100.

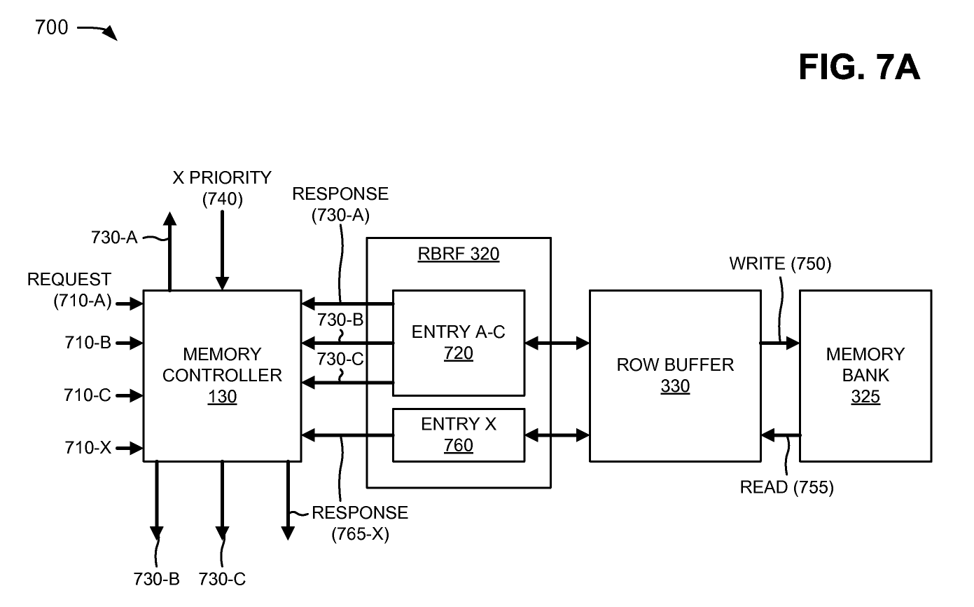

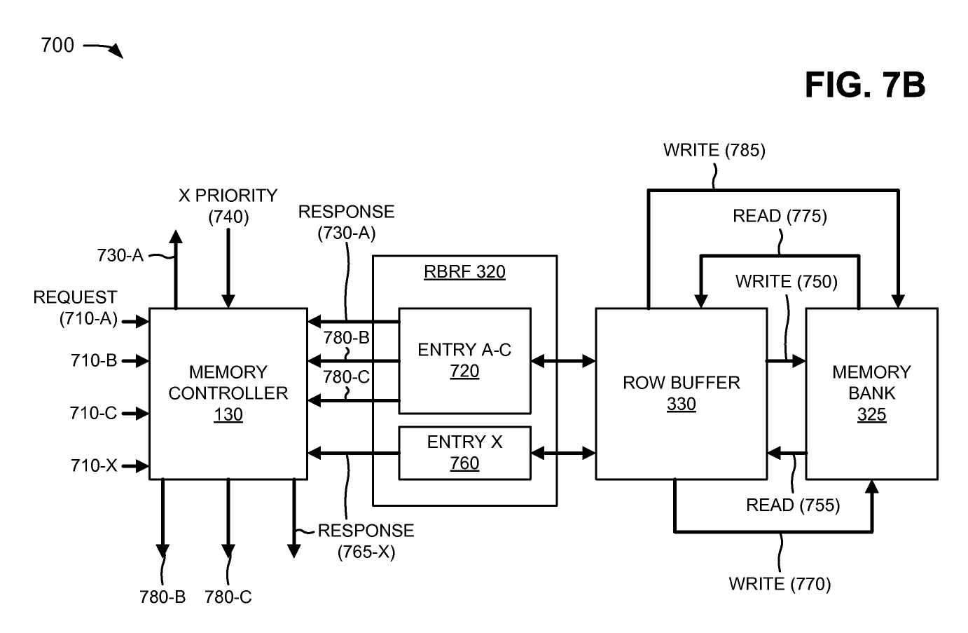

FIGS. 7A and 7B are diagrams of example operations 700 capable of being performed by components of memory arrangement 100. As shown, the components of memory arrangement 100 may include memory controller 130, RBRF 320, memory bank 325, and row buffer 330. Memory controller 130, RBRF 320, memory bank 325, and row buffer 330 may include the features described above in connection with, for example, one or more of FIGS. 1-6.

As further shown in FIG. 7A, memory controller 130 may receive four memory requests 710-A, 710-B, 710-C, and 710-X. Information requested by memory requests 710-A, 710-B, and 710-C may reside in a row stored in row buffer 330, while information requested by memory request 710-X may reside in a row stored in memory bank 325. Memory controller 130 may create an entry 720 in RBRF 320 for information stored in row buffer 330, and may retrieve a response 730-A to memory request 710-A from entry 720. Memory controller 130 may provide response 730-A to a requesting source (e.g., processing unit 220). After serving memory request 710-A, memory controller 130 may receive a priority indication 740 that memory request 710-X needs to be processed (i.e., take priority) because it is holding up other processes (e.g., of processing unit 220).

In one example embodiment, and as shown in FIG. 7A, memory controller 130 may ignore indication 740, and may retrieve responses 730-B and 730-C, to memory requests 710-B and 710-C, from entry 720. Memory controller 130 may provide responses 730-B and 730-C to a requesting resource, such as processing unit 220, and may instruct row buffer 330 to write its stored row to memory bank 325, as indicated by reference number 750. Memory controller 130 may instruct row buffer 330 to read information requested by memory request 710-X from memory bank 325, as indicated by reference number 755. Memory controller 130 may create an entry 760 in RBRF 320 for information stored in row buffer 330, and may retrieve a response 765-X, to memory request 710-X, from entry 760. Memory controller 130 may provide response 765-X to a requesting source (e.g., processing unit 220). Such an embodiment may minimize power consumption by memory arrangement 100 but may not improve global performance of a device (e.g., device 200).

In an alternative example embodiment, and as shown in FIG. 7B, memory controller 130 may proactively close a row buffer so that closing the row buffer need not be performed at a later time, which may slow performance of device 200. As shown in FIG. 7B, prior to responding to memory requests 710-B and 710-C, memory controller 130 may instruct row buffer 330 to write its stored row to memory bank 325, as indicated by reference number 750. Memory controller 130 may instruct row buffer 330 to read information requested by memory request 710-X from memory bank 325, as indicated by reference number 755. Memory controller 130 may create entry 760 in RBRF 320 for information stored in row buffer 330, and may retrieve response 765-X, to memory request 710-X, from entry 760. Memory controller 130 may provide response 765-X to a requesting source (e.g., processing unit 220). Memory controller 130 may again instruct row buffer 330 to write its stored row to memory bank 325, as indicated by reference number 770. Memory controller 130 may instruct row buffer 330 to read information requested by memory requests 710-B and 710-C from memory bank 325, as indicated by reference number 775. Memory controller 130 may re-create entry 720 in RBRF 320 for information stored in row buffer 330, and may retrieve responses 780-B and 780-C, to memory requests 710-B and 710-C, from entry 720. Memory controller 130 may provide responses 780-B and 780-C to a requesting source, and may instruct row buffer 330 to write its stored row to memory bank 325, as indicated by reference number 785. This embodiment may improve global performance of a device (e.g., device 200), but may require higher power consumption than the embodiment of FIG. 7A.

The embodiments depicted in FIGS. 7A and 7B provide examples of how memory controller 130 may employ different strategies to optimize memory arrangement 100, maximize performance of memory arrangement 110, minimize power consumption, or optimize other objectives. Memory controller 130 may manage RBRF 320 to employ the different strategies.

Although FIGS. 7A and 7B show example operations 700 capable of being performed by components of memory arrangement 100, in other embodiments, memory arrangement 100 may perform less operations, different operations, or additional operations than depicted in FIGS. 7A and 7B. Alternatively, or additionally, one or more components of memory arrangement 100 may perform one or more other operations described as being performed by one or more other components of memory arrangement 100.

### Example Processes

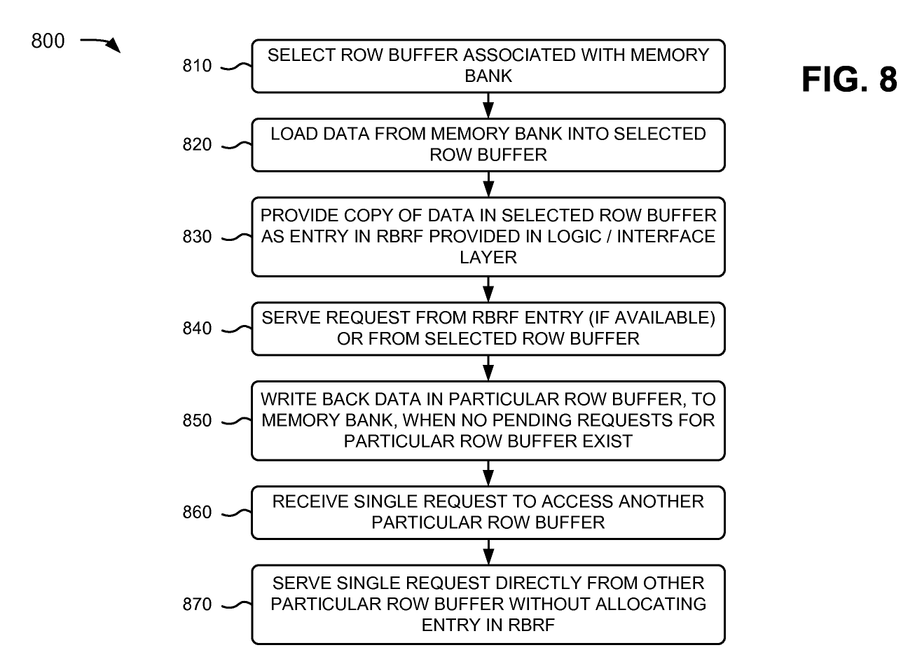

FIG. 8 is a flow chart of an example process 800 for utilizing a RBRF according to an embodiment described herein. In one embodiment, process 800 may be performed by device 200 (FIG. 2). In another embodiment, some or all of process 800 may be performed by one or more components of device 200, such as by memory controller 130.

As illustrated in FIG. 8, process 800 may include selecting a row buffer associated with a memory bank (block 810), and loading data from memory bank into the selected row buffer (block 820). For example, in embodiments described above in connection with FIG. 4, rather than using a LRU entry, memory controller 130 may select one of row buffers 330 from which to load data into RBRF 320, as indicated by reference 410. Memory controller 130 may instruct memory bank 325 to load data (e.g., a row) from memory bank 325 into the selected one of row buffers 330 (e.g., row buffer 330-1).

As further shown in FIG. 8, process 800 may include providing a copy of data in the selected row buffer as an entry in a RBRF provided in a logic/interface layer (block 830), and serving a request from the RBRF entry, if available, or from the selected row buffer (block 840). For example, in embodiments described above in connection with FIG. 4, memory controller 130 may select row buffer 330-1, and may load a copy of data from row buffer 330-1, as indicated by reference number 420, into entry 430-1 of RBRF 320. Memory controller 130 may load copies of data from row buffers 330-2 and 330-3 into entries 430-2 and 430-3, respectively, of RBRF 320. When memory controller 130 receives memory request 440, memory controller 130 may determine whether the information requested by memory request 440 is stored in an entry of RBRF 320. If the information requested by memory request 440 is stored in an entry of RBRF 320, memory controller 130 may serve memory request 440 with the entry of RBRF 320. If the information requested by memory request 440 is not stored in an entry of RBRF 320, memory controller 130 may serve memory request 440 via one of row buffers 330.

Returning to FIG. 8, process 800 may include writing back data in a particular row buffer, to the memory bank, when no pending requests for the particular row buffer exist (block 850), receiving a single request to access another particular row buffer (block 860), and serving the single request directly from the other particular row buffer without allocating an entry in the RBRF (block 870). For example, in embodiments described above in connection with FIG. 4, memory controller 130 may explicitly close rows in row buffers 330, as indicated by reference number 470, rather than closing a row in response to an activation request for a row that is not already open. Memory controller 130 may proactively close a particular row when memory controller 130 determines that it is unlikely that there will be any further requests for the particular row. When memory controller 130 closes a row in a row buffer 330 (e.g., row buffer 330-3), data contained in row buffer 330-3 may be written back to memory bank 325, as indicated by reference number 480. In one example, memory controller 130 may determine whether to create an entry in RBRF 320 for a memory request. If a particular row is requested by a single memory request, memory controller 130 may serve the single memory request directly from one of row buffers 330, without creating an entry in RBRF 320.

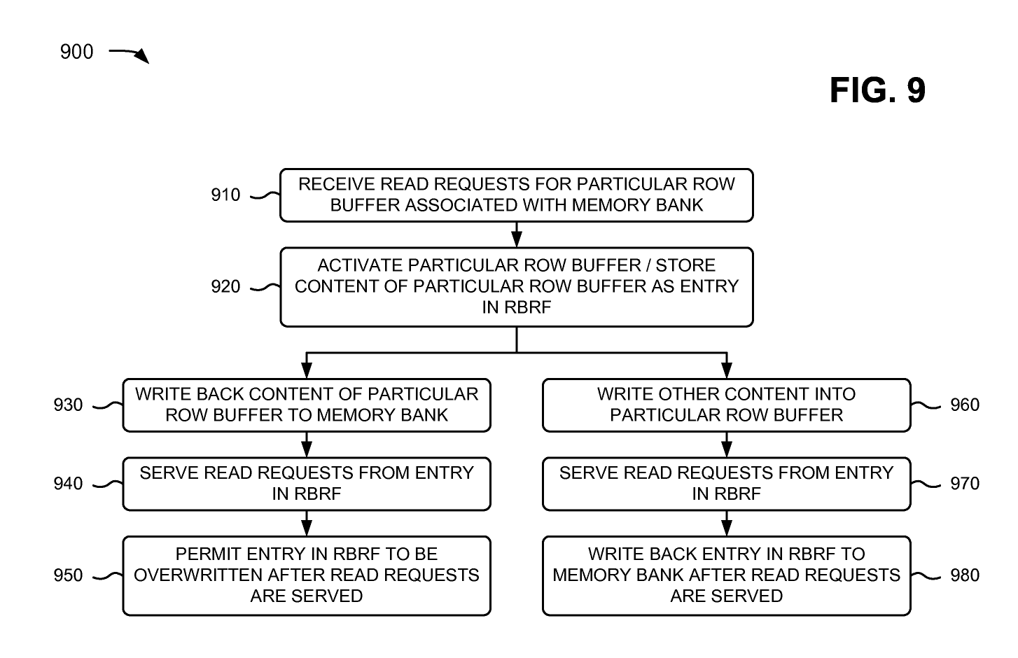

FIG. 9 is a flow chart of another example process 900 for utilizing a RBRF according to an embodiment described herein. In one embodiment, process 900 may be performed by device 200 (FIG. 2). In another embodiment, some or all of process 900 may be performed by one or more components of device 200, such as by memory controller 130.

As illustrated in FIG. 9, process 900 may include receiving read requests for a particular row buffer associated with a memory bank (block 910), and activating the particular row buffer and storing content of the particular row buffer as an entry in a RBRF (block 920). For example, in embodiments described above in connection with FIG. 5, memory request queue 305 may include several read requests 510 for a row contained in row buffer 330. However, memory request queue 305 may not include write requests for the row contained in row buffer 330. Based on read requests 510, scheduler 310 may cause a copy of data (e.g., a row) stored in row buffer 330 to be stored in an entry 520 of RBRF 320.

As further shown in FIG. 9, process 900 may include writing back content of the particular row buffer to the memory bank (block 930), serving the read requests from the entry in the RBRF (block 940), and permitting the entry in the RBRF to be overwritten after the read requests are served (block 950). For example, in embodiments described above in connection with FIG. 5, after creating entry 520 in RBRF 320, scheduler 310 may close the row stored in row buffer 330, as indicated by reference number 530. Row buffer 330, in turn, may write back its stored data to memory bank 325, as indicated by reference number 540. After all of read requests 510 have been served by entry 520 in RBRF 320, scheduler 310 may overwrite 560 entry 520 in RBRF 320, without writing back the data of entry 520 to memory bank 325, since the data was already written back to memory bank 325 and was not modified.

Returning to FIG. 9, process 900 may alternatively include writing other content into the particular row buffer (block 960), serving the read requests from the entry in the RBRF (block 970), and writing back the entry in the RBRF to the memory bank after the read requests are served (block 980). For example, in embodiments described above in connection with FIG. 5, scheduler 310 may cause a copy of the row stored in row buffer 330 to be stored in entry 520 of RBRF 320, and may (e.g., subject to circuit-level timing constraints) activate another row and store the other row in row buffer 330. In such an arrangement and after read requests 510 have been served by entry 520 in RBRF 320, scheduler 310 may transfer the data of entry 520 to row buffer 330 and may instruct row buffer 330 to write back the transferred data of entry 520 to memory bank 325.

### CONCLUSION

Systems and/or methods described herein may utilize a logic/interface layer of a memory device to implement a RBRF. The RBRF may permit a memory to simultaneously keep multiple rows of memory open in order to improve memory access times. Multiple internal row buffers of the memory device may permit multiple rows of memory to be simultaneously opened, while the RBRF may maintain entries associated with the internal row buffers. The entries in the RBRF may be visible to and controlled by a memory controller. The memory controller may open or close particular rows at particular times, which may enable the memory controller to more efficiently schedule memory requests to improve performance, fairness, and/or power.

The foregoing description of embodiments provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 8 and 9, the order of the blocks may be modified in other embodiments. Further, non-dependent blocks may be performed in parallel.

It will be apparent that aspects, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein. The software may also include hardware description language (HDL), Verilog, Register Transfer Level (RTL), Graphic Database System (GDS) II data or the other software used to describe circuits and arrangement thereof. Such software may be stored in a computer readable media and used to configure a manufacturing process to create physical circuits capable of operating in manners which embody aspects of the present invention.

Further, certain embodiments described herein may be implemented as “logic” that performs one or more functions. This logic may include hardware, such as a processor, an ASIC, or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
storing data from each of a plurality of row buffers of a multiple-bank memory device in a corresponding entry of a row buffer register file (RBRF) provided in a logic/interface layer of the memory device; and
serving a first memory request from an entry in the RBRF responsive to determining that the entry stores data from a first row buffer associated with the first memory request.

2. The method of claim 1, further comprising:
serving a second memory request from a second row buffer associated with the second memory request responsive to determining that the RBRF does not contain an entry storing data from the second row buffer.

3. The method claim 1, further comprising:
selecting a particular row from the plurality of row buffers;
loading data from a memory bank into the selected row buffer;
providing a copy of the data in the selected row buffer as a particular entry in the RBRF; and
serving at least one memory request from one of the particular entry in the RBRF or from the selected row buffer.

4. The method of claim 3, further comprising:
writing back the data, in the selected row buffer, to the memory bank when no pending memory requests for the data exist.

5. The method of claim 1, further comprising:
receiving a single memory request to access data in a particular row buffer of the plurality of row buffers; and
serving the single memory request directly from the particular row buffer, without allocating an entry in the RBRF.

6. The method of claim 1, further comprising:
receiving a plurality of read requests for a particular row buffer of the plurality of row buffers;
activating the particular row buffer; and
storing content of the particular row buffer as another entry in the RBRF.

7. The method of claim 6, further comprising:
writing back the content of the particular row buffer to a particular memory bank of the memory device;
serving read requests from the other entry in the RBRF; and
overwriting the other entry in the RBRF after the read requests are served.

8. The method of claim 6, further comprising:
writing other content into the particular row buffer;
serving read requests from the other entry in the RBRF; and
writing back the other entry in the RBRF to a particular memory bank of the memory device, after the read requests are served.

9. A memory controller of a device, the memory controller comprising:
processing logic to:
store data from each of a plurality of row buffers of a multiple-bank memory device in a corresponding entry of a row buffer register file (RBRF) provided in a logic/interface layer of the memory device, and
serve a first memory request from an entry in the RBRF responsive to determining that the entry stores data from a first row buffer associated with the first memory request.

10. The memory controller of claim 9, where the processing logic is further to:
serve a second memory request from a second row buffer associated with the second memory request responsive to determining that the RBRF does not contain an entry storing data from the second row buffer.

11. The memory controller of claim 9, where the processing logic is further to:
select a particular row from the plurality of row buffers,
load data from a memory bank into the selected row buffer,
provide a copy of the data in the selected row buffer as a particular entry in the RBRF, and
serve at least one memory request from one of the particular entry in the RBRF or from the selected row buffer.

12. The memory controller of claim 11, where the processing logic is further to:
write back the data, in the selected row buffer, to the memory bank when no pending memory requests for the data exist.

13. The memory controller of claim 9, where the processing logic is further to:
receive a single memory request to access data in a particular row buffer of the plurality of row buffers, and
serve the single memory request directly from the particular row buffer, without allocating an entry in the RBRF.

14. A device comprising:
a memory device that includes:
a memory layer with memory banks and corresponding row buffers, and
a logic/interface layer with a row buffer register file (RBRF); and
a memory controller to:
store data from each of the row buffers in a corresponding entry of the RBRF, and
serve a first memory request from an entry in the RBRF responsive to determining that the entry stores data from a first row buffer associated with the first memory request.

15. The device of claim 14, where the memory controller is further to:
serve a second memory request from a second row buffer associated with the second memory request responsive to determining that the RBRF does not contain an entry storing data from the second row buffer.

16. The device of claim 14, where the memory controller includes:
a memory request queue to receive and store memory requests; and
a RBRF table that stores tags associated with entries provided in the RBRF.

17. The device of claim 14, where the memory controller is further to:
write back data, in one of the row buffers, to one of the memory banks when no pending memory requests for the data exist in the memory request queue.

18. The device of claim 14, where the memory controller is further to:
select a particular row from the row buffers,
load data from a memory bank into the selected row buffer,
provide a copy of the data in the selected row buffer as a particular entry in the RBRF, and
serve at least one memory request from one of the particular entry in the RBRF or from the selected row buffer.

19. The device of claim 18, where the memory controller is further to:
write back the data, in the selected row buffer, to the memory bank when no pending memory requests for the data exist.

20. The device of claim 14, where the memory controller is further to:
receive a single memory request to access data in a particular row buffer, and
serve the single memory request directly from the particular row buffer, without allocating an entry in the RBRF.

21. The device of claim 14, further comprising:
a processing unit with multiple cores,
where the memory controller is further to:
create a dedicated entry in the RBRF for one of the multiple cores of the processing unit, and
create multiple first-come, first-served entries in the RBRF for the one of the multiple cores or for remaining cores of the processing unit.
